(19) United States
(12) Patent Application Publication
(10) Pub. No.: US 2013/0257596 A1
(43) Pub. Date: Oct. 3, 2013

(54) RFID READER EXTENDER

(71) Applicant: TYCO ELECTRONICS UK LTD, Wiltshire (GB)

(72) Inventor: Ian Miles Standish, Flintshire (GB)

(73) Assignee: Tyco Electronics UK Ltd, Wiltshire (GB)

(21) Appl. No.: 13/850,560

(22) Filed: Mar. 26, 2013

Related U.S. Application Data
(60) Provisional application No. 61/618,111, filed on Mar. 30, 2012.

(51) Int. Cl. G06K 7/10

(52) U.S. Cl. CPC G06K 7/10366
USPC 340/10.1

(57) ABSTRACT

One exemplary embodiment is directed to an apparatus for reading an RFID tag comprising an RFID reader comprising: an RFID transceiver and a first coil. The apparatus further comprises an extender configured to attach to the RFID reader, the extender comprising a second coil. The extender is configured to couple the first coil and the second coil to one another when the extender is attached to the RFID reader. Another exemplary embodiment is directed to an extender for use with an RFID reader that is configured to read an RFID tag using a first coil included in the RFID reader. The extender comprises an elongated structure configured to attach to the RFID reader and a second coil attached to the elongated structure. The extender is configured to couple the first coil and the second coil to one another when the extender is attached to the RFID reader.

### CROSS-REFERENCE TO RELATED APPLICATION

This application claims the benefit of U.S. Provisional Patent Application Ser. No. 61/618,111, filed on Mar. 30, 2012, which is hereby incorporated herein by reference.

### BACKGROUND

Patching systems are commonly used in communication networks in order to provide flexibility in implementing communication links. One example of a patching system is a patch panel. A patch panel typically includes a panel in which a plurality of ports are formed or otherwise housed. Each port includes a “front” connector and a “rear” connector (or other attachment mechanism such as a punch-down block or permanently attached optical fiber pigtail). The port is configured to communicatively couple any cable attached to the front connector of that port to any cable that is attached to the rear of that port. Other patching systems are implemented in similar ways.

Many types of physical layer management (PLM) systems have been developed in order to keep track of which cables are attached to which ports of a patching system. In one type of system, each connector that is attached to a front connector of a patch panel has a radio frequency identification (RFID) tag attached to it. An RFID reader can then be used to wirelessly read an identifier from each connector's RFID tag in order to keep track of what connectors and cables are attached to the front connectors of the patch panel.

However, such conventional RFID PLM systems are often not suitable for use with high density patching systems. Moreover, conventional RFID PLM systems are typically not used to read RFID tags attached to connectors attached to the rear of the ports of a patching system.

### SUMMARY

One exemplary embodiment is directed to an apparatus for reading an RFID tag comprising an RFID reader comprising: an RFID transceiver and a first coil. The apparatus further comprises an extender configured to attach to the RFID reader, the extender comprising a second coil. The extender is configured to couple the first coil and the second coil to one another when the extender is attached to the RFID reader.

Another exemplary embodiment is directed to an extender for use with an RFID reader that is configured to read an RFID tag using a first coil included in the RFID reader. The extender comprises an elongated structure configured to attach to the RFID reader and a second coil attached to the elongated structure. The extender is configured to couple the first coil and the second coil to one another when the extender is attached to the RFID reader.

### DRAWINGS

FIG. 1 is a block diagram of one exemplary embodiment of a physical layer management (PLM) system.

FIG. 2 illustrates a portion of the patch panel shown in FIG. 1.

FIG. 3 illustrates a portion of the patch panel shown in FIG. 1.

FIG. 4 illustrates one exemplary embodiment of an RFID reader pen and extender where the extender is detached from the RFID reader pen.

FIG. 5 shows the extender of FIG. 4 attached to the RFID reader pen of FIG. 4.

FIG. 6 is a circuit diagram illustrating one exemplary embodiment of a circuit for use in the extender of FIG. 4 suitable for coupling the RFID reader pen of FIG. 4 with a RFID tag.

FIG. 7 illustrates another exemplary embodiment of an extender, RFID reader pen, and patch panel system.

### DETAILED DESCRIPTION

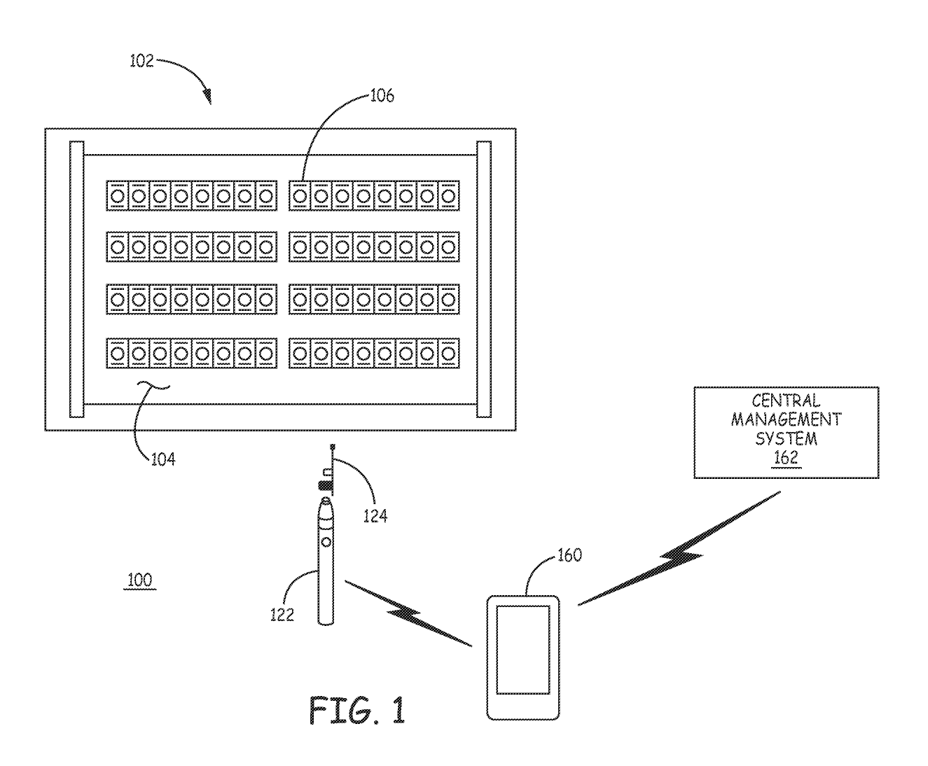

FIGS. 1-3 are diagrams showing one exemplary embodiment of a physical layer management (PLM) system 100. The PLM system 100 comprises a patching system 102.

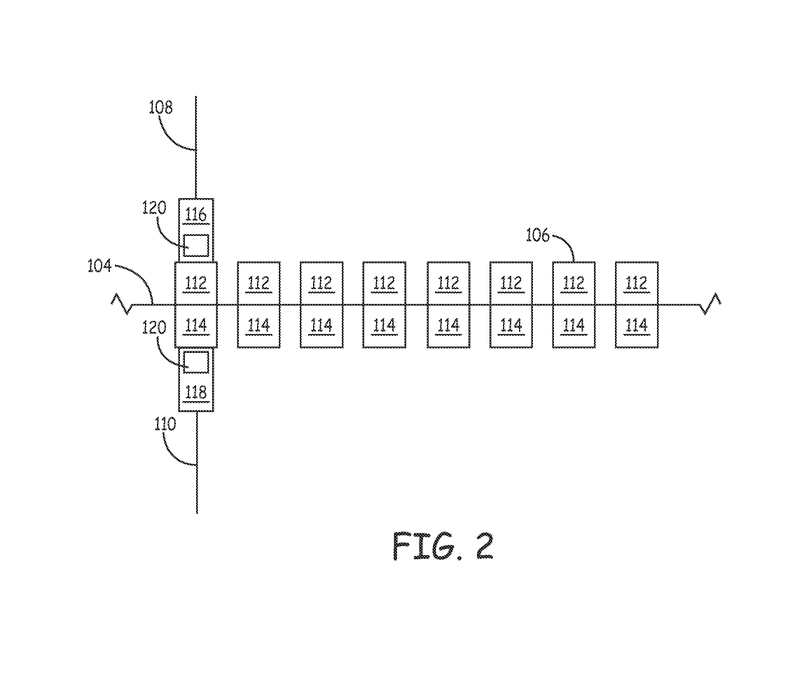

The patching system 102 comprises at least one panel 104 that supports a plurality of ports 106. Each port 106 is configured to communicatively couple a respective front cable 108 (shown in FIG. 2) to a respective rear cable 110 (shown in FIG. 2) so that one or more information bearing signals can be communicated between that front cable 108 and that rear cable 110.

Each port 106 comprises a respective front connector or other attachment mechanism 112 (shown in FIG. 2) that is mounted to (or otherwise positioned on or near) the panel 104 so that a respective front cable 108 can be physically attached to the front of that port 106. Each port 106 comprises a respective rear connector or other attachment mechanism 114 (shown in FIG. 2) that is mounted to (or otherwise positioned on or near) the panel 104 so that a respective rear cable 110 can be physically attached to the rear of that port 106.

In the exemplary embodiment shown in FIGS. 1-3, each port 106 is implemented using a fiber adapter and is also referred to here as a “fiber adapter 106”. In this exemplary embodiment, the front connector or other attachment mechanism 112 in each fiber adapter 106 comprises a front optical jack (for example, an LC jack) and is also referred to here as a “front optical jack 112”. Likewise, the rear connector or other attachment mechanism 114 in each fiber adapter 106 comprises a rear optical jack (for example, an LC jack) and is also referred to here as a “rear optical jack 114”.

In this exemplary embodiment, each front cable 108 is implemented using a respective front optical cable and is also referred to here as the “front optical cable 108”. In this exemplary embodiment, each front optical cable 108 is terminated using a respective front optical cable connector 116 (for example, an LC connector) (shown in FIG. 2) that is configured to be connected to the particular front optical jacks 112 used in the fiber adapters 106. Likewise, each rear optical cable 110 is terminated using a respective rear optical cable connector 118 (for example, an LC connector) (shown in FIG. 2) that is configured to be connected to the particular rear optical jacks 114 used in the fiber adapters 106.

It is to be understood, however, that the ports 106 can be implemented in other ways. For example, the ports 106 can be implemented using other types of fiber adapters, the ports 106 can be implemented to connect other types of cables (for example, to electrically connect copper front and rear cables 108 and 110), and/or can be implemented so that the front connector or other attachment mechanism 112 or the rear connector or other attachment mechanism 114 is implemented using a non-connectorized attachment mechanism (for example, in the case of copper cables, using a punch-down block to which a rear cable 110 can be attached or, in the case of optical fibers, by using a fiber adapter that is manufactured with an optical pigtail permanently attached to the rear of it).

In the exemplary embodiment shown in FIGS. 1-3, each front cable connector 116 and each rear cable connector 118 (or the associated front or rear optical cable 108 or 110) has a respective RFID tag 120 (shown in FIG. 2) attached to or otherwise associated with it. For example, each RFID tag 120 can be attached to the cable connector 116 or 118 (or the associated front or rear optical cable 108 or 110) using a heat-shrink label or tubing, tape, or adhesive. The RFID tag 120 can also be integrated into the cable connector 116 or 118 (or the associated front or rear optical cable 108 or 110).

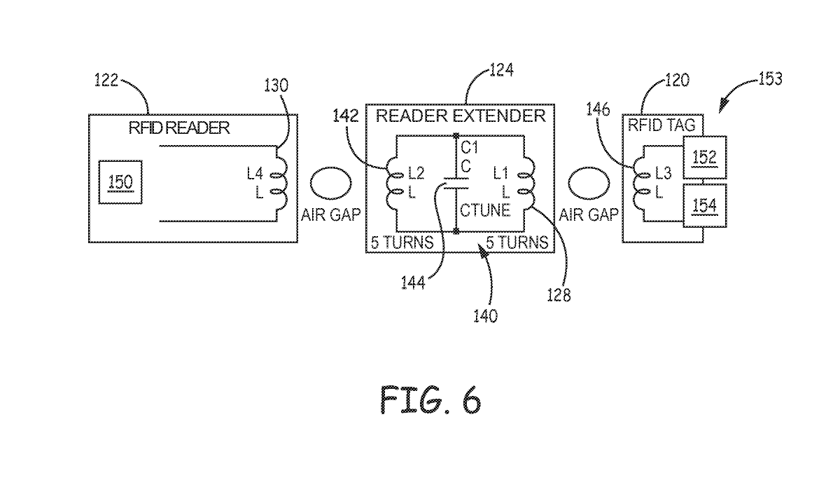

Each RFID tag 120 stores a unique identifier for the associated connector 116 or 118 and/or cable 108 or 110. This identifier can be used to identify which cable 108 or 110 is attached to each port 106 of the patch panel 102. In some implementations, the RFID tags 120 are used to store other information and/or are written to as well as read from. Typically, each RFID tag 120 includes a non-volatile memory 154 (shown in FIG. 6) that is used to store such information and RFID transponder electronics 153 (shown in FIG. 6) to enable the RFID tag 120 to be energized by, and communicate with, an RFID reader.

In the exemplary embodiment described here in connection with FIGS. 1-3, the information stored in the RFID tags 120 is read using an RFID reader 122. In this embodiment, the RFID reader 122 is implemented using an RFID reader pen (and the RFID reader 122 is also referred here as the “RFID reader pen 122”), though it is to be understood that the RFID reader 122 need not be implemented using an RFID reader pen and can be implemented using other types of RFID readers including, for example, other types of handheld RFID readers. The RFID reader pen 122 can be implemented using a standard commercially available RFID reader pen that is modified as described here. The RFID reader pen 122 includes standard RFID reader electronics for interrogating an RFID tag 120. More specifically, the RFID reader 122 is configured to broadcast a radio frequency (RF) signal that is suitable to energize an RFID tag 120 and, in response, cause the RFID tag 120 to transmit at least some of the information stored in it. In the exemplary embodiment shown in FIGS. 1-6, the RFID reader pen 122 is communicatively coupled to a handheld device 160. For example, the handheld device 160 can be implemented using a computer, smartphone, portable computer, or the like that is coupled to reader pen 122 using, for example, a wired connection or wireless connection such as a BLUETOOTH connection.

The information that is read from the RFID tags 120 can then be used for various PLM-related purposes. For example, the information read from the RFID tags 120 can be communicated to a central management system 162 that tracks which cables are attached to the patch panel 102. Also, the information read from RFID tags 120 can be used in assisting a technician in moving, adding, or otherwise changing a connection that is made at the patch panel 102. For example, the information that is read from the RFID tags 120 can be used by the central management system 162 and/or the handheld device 160 in connection with guiding a technician in carrying out a work order by visually signally which ports are to be affected by a particular step in the work order using LEDs included in the patch panel 102. Also, the information read from the RFID tags 120 can be used to assist in determining whether each step in the work order was properly carried out. The information read form the RFID tags 120 can be used for other purposes as well.

In general, a conventional RFID reader pen includes an RFID coil in its tip. Such a conventional RFID reader pen can be used to read an RFID tag by positioning the RFID coil in the tip of the RFID reader pen near the RFID tag and then pressing a button included on the RFID reader pen. Pressing the button causes the RFID reader pen to interrogate the RFID tag. The information read from the RFID tag is then communicated to the computer or other device that RFID reader pen is communicatively coupled to. Also, a conventional RFID reader pen typically includes a light emitting diode (LED) in the tip that is illuminated when the RFID reader pen is being used to interrogate an RFID tag in order to provide a visual confirmation that such interrogation is occurring.

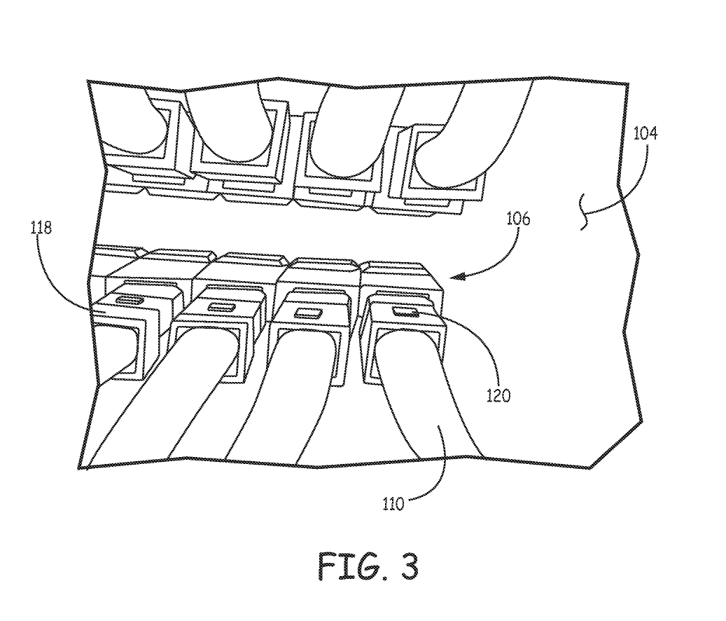

However, it may be difficult to use a conventional RFID reader pen in the conventional manner to interrogate RFID tags attached to connector or cables that are connected to ports of a patch panel without removing the cables from the ports of the patch panel. More specifically, it may be difficult to position the RFID coil in the tip of a conventional RFID reader near the RFID tag to be read without removing cables from the ports of the patch panel (for example, due to the density or arrangement of the ports in the patch panel, the shape of the cable connectors, or the routing of the cables). FIG. 3 illustrates a portion of one exemplary implementation of the patch panel 102 shown in FIG. 1. In the example shown in FIG. 3, it would be difficult to position the tip of a conventional RFID reader pen near an RFID tag 120 mounted on an front connector 118 that is inserted into a fiber adapter 106 without removing cables 108 from the fiber adapter 106 of the patch panel 106 due the density and arrangement of the fiber adapters 106.

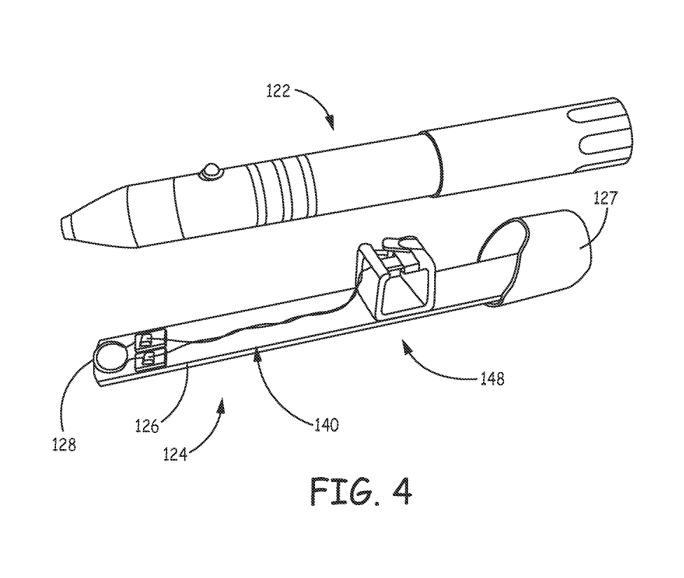

In the exemplary embodiment shown in FIGS. 1-6, such issues with using an RFID reader pen 122 in the conventional manner to read the RFID tags 120 are addressed by using an extender 124 (shown in more detail in FIGS. 4-6).

The extender 124 comprises an elongated structure 126 that is physically attached to the body of the RFID reader pen 122. In the exemplary embodiments described here, the elongated structure 126 is implemented using a nib (and the elongated structure 126 is also referred to here as “nib 126”). However, it is to be understood that other elongated structures 126 can be used.

In the embodiment shown in FIGS. 4-6, the nib 126 can be physically attached to the body of the RFID pen 122 so that the extender 124 can be easily attached to and removed from the RFID reader pen 122 (for example, to reduce the likelihood of damaging the extender 124 when not in use, to more conveniently pack the RFID reader pen 122 when not in use, or to enable a damaged extender 124 to be replaced in the field). In this embodiment, the extender 124 comprises a collar 127 that is slipped over the tip of the RFID reader pen 122 and slid down the top portion of the RFID reader pen 122 when the extender 124 is attached to the body of the RFID reader pen 122.

The extender 124 can be removably attached to the body of the RFID reader pen 122 in other ways (for example, using a threaded connection, friction fit, clip, or the like). The extender 124 can be physically attached to the body of the RFID reader pen 122 in other ways, for example, by using adhesive or heat-shrink tape, other adhesives or fasteners, or by integrating the extender 124 into the body of the RFID reader pen 122.

A coil or other inductor 128 is mounted on or near one end of the elongated structure 126 (typically, the end that is opposite the end that attached to the RFID reader 122). In this exemplary embodiment, the coil or other inductor 128 is mounted on the tip of the nib 126. The coil or other inductor 128 is coupled to a coil or other inductor 130 in the tip of the RFID reader pen 122. The coil or other inductor 128 is also referred to here as the “tip coil” 128. The coil or other inductor 130 in the tip of the RFID reader pen 122 is also referred to here as the “pen coil” 130.

In the exemplary embodiment shown in FIGS. 3-6, the tip coil 128 located on the tip of the nib 126 is inductively coupled to the pen coil 130 in the tip of the RFID reader pen 122. In other embodiments, the tip coil 128 in the tip of the nib 126 is coupled to the pen coil 130 in the tip of the RFID reader pen 122 in other ways.

More specifically, in the exemplary embodiment shown in FIGS. 3-6, the tip coil 128 and pen coil 130 are coupled to each other in a wireless manner where the tip coil 128 and the pen coil 130 do not need to physically contact each other (though it is to be understood that the tip coil 128 and the pen coil 130 can be coupled to each other in a wired manner where the tip coil 128 and the pen coil 130 physically contact each other).

In the exemplary embodiment shown in FIGS. 3-6, the tip coil 128 and pen coil 130 are coupled to each other in a bi-directional manner so that any signal transmitted by the RFID reader pen 122 is also radiated from the tip coil 128 and so that any signal received at the tip coil 128 is also received by the pen coil 130.

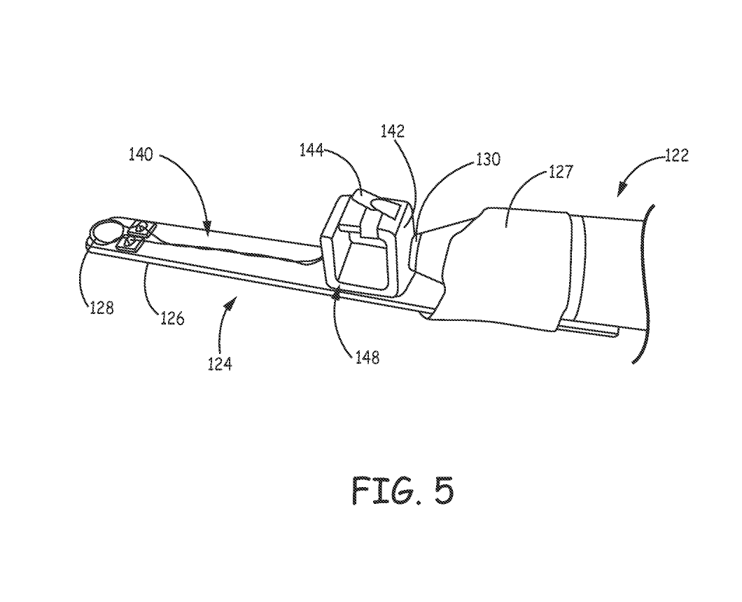

In the exemplary embodiment shown in FIGS. 3-6, the extender 124 comprises a circuit 140 (shown in more detail in FIG. 6) that includes the tip coil 128 and a pickup coil 142. The pickup coil 142 is positioned on the nib 126 so that it will be located near the pen coil 130 in the tip of the RFID reader pen 122 when the extender 124 is attached to the RFID reader pen 122 (as shown in FIG. 5).

In the exemplary embodiment shown in FIGS. 3-6, the circuit 140 is broadly tuned using a parallel capacitor 144 (shown in FIG. 6) that is also included in the circuit 140. The circuit 140 is tuned to improve the coupling factor between the tip coil 128 in the tip of the RFID reader pen 122 and a coil 146 in the RFID tag 120 at the particular RF frequency that is used to interrogate the RF tag 120.

In the embodiment shown in FIGS. 3-6, the extender 124 further comprises a pen adapter 148 that is attached to the nib 126. The pen adapter 148 is configured to receive the tip of the RFID reader pen 122 when the extender 124 is attached to the body of the RFID reader pen 122 by sliding the collar 127 over the top portion of the RFID reader pen 122. The pen adapter 148 is configured to receive the tip of the RFID reader pin 122 and stop the extender 124 from being slid further down the top portion of the RFID reader pen 122 (for example, by shaping at least a portion of the inside of the pen adapter 148 to contact at least a portion of the tip of the RFID reader pen 122 when the collar 127 has been slid far enough down).

The pen adapter 148 is also configured to hold the tip of the RFID reader pen 122 in place while the RFID reader pen 122 is attached to the extender 124. The pen adapter 148 is configured to hold the tip of the RFID reader pen 122 so that the pen coil 130 is positioned near the pickup coil 142 of the extender 124 when the extender 124 is attached to the body of the RFID reader pen 122. More specifically, the pen adapter 148 is configured to hold the tip of the RFID reader pen 122 so that the pen coil 130 is sufficiently close to the pickup coil 142 of the extender 124 to couple the tip coil 128 mounted to the tip of the nib 126 to the pen coil 130.

In the exemplary embodiment shown in FIGS. 3-6, the pen adapter 148 is formed out of a clear or translucent material (such as plastic) so that a user of the RFID reader pen 122 can to see if any LED included in the tip of the RFID reader pen 122 is illuminated or not.

In operation, the extender 124 can be attached to the RFID reader pen 122 by sliding the collar 127 over the tip of the RFID reader pen 122 and sliding it down the top portion of the RFID reader pen 122. The collar 127 is slid down the top portion of the RFID reader pen 122 until the tip of the RFID reader pen 122 is received and stopped by the pen adapter 148. This positions the tip of the RFID reader pen 122 so that the pickup coil 142 is located near the pen coil 130 in the tip of the RFID reader pen 122.

The RFID reader pen 122 can then be used to interrogate an RFID tag 120 by placing the tip of the extender 124 near or on the RFID tag 120 and causing an RFID transceiver 150 (shown in FIG. 6) in the RFID reader 122 to generate an RF signal at a predetermined RF frequency (for example, by pressing a button included in the RF reader pen 122 for that purpose). The RF signal is radiated from the pen coil 130 in the tip of the RFID reader pen 122. This RF signal induces an RF signal in the pickup coil 142, which is coupled via the circuit 140 to the tip coil 128 positioned on the tip of the nib 126. As a result, the RF signal is radiated from the tip coil 128. This RF signal induces an RF signal in the coil 146 in the RFID tag 120, which energizes the RFID tag 120. An RFID transceiver 152 (shown in FIG. 6) in the RFID tag 120 then decodes the RFID interrogation signal.

In this example, this RF signal transmitted by the RFID reader pen 122 is encoded with data indicating that any RFID tag 120 receiving that signal should read at least some of the information stored in the non-volatile memory 154 (shown in FIG. 6) included in that RFID tag 120 and transmit an RF signal that is encoded with at least some of the information read from the non-volatile memory 154. The RF signal transmitted by the RFID tag 120 is radiated from the coil 146 in the RFID tag 120. This RF signal induces an RF signal in the tip coil 128 in the tip of the extender 124, which is coupled via the circuit 140 to the pickup coil 142. As a result, the RF signal is radiated from the pickup coil 142. This RF signal induces an RF signal in the tip coil 130 in the RFID reader pen 122. The RFID transceiver 150 in the RFID reader pen 122 then decodes the RF signal to extract the information read from the non-volatile memory 154 in the RFID tag 120.

In this way, the RFID reader pen 122 with the extender 124 attached to it can be used to more easily position the tip of the extender 124 near an RFID tag 120 mounted on a connector that is inserted into a fiber adapter 106 in a high-density patch panel 102 of the type shown in FIGS. 1-3. The RFID tag 120 can then be interrogated without removing cables 108 from the fiber adapter 106 of the patch panel 106.

In one implementation of the embodiment shown in FIGS. 1-6, the tip coil 128 and the pickup coil 142 are each implemented using a respective coil made out of 5 turns of copper wire (though it is to be understood that a different number of turns can be used and that both coils need not have the same number of turns). In another implementation, the tip coil 128 and the pickup coil 142 are implemented using respective low profile printed circuit board (PCB) planar inductors or transformers.

Although the RFID reader pen 122 is described here in connection with the embodiment shown in FIGS. 1-6 as including the RFID transceiver 150, it is to be understood that the RFID reader pen 122 itself need not include the RFID transceiver 150. For example, the RFID transceiver 150 can be housed within a separate unit to which the RFID reader pen 122 is communicatively coupled.

As noted above, although the preceding examples have been described above in connection with optical connectors and adapters, one of ordinary skill in the art can recognize that the techniques described here can be used with other types of communication media, such as copper communication media, connectors, and jacks and plugs.

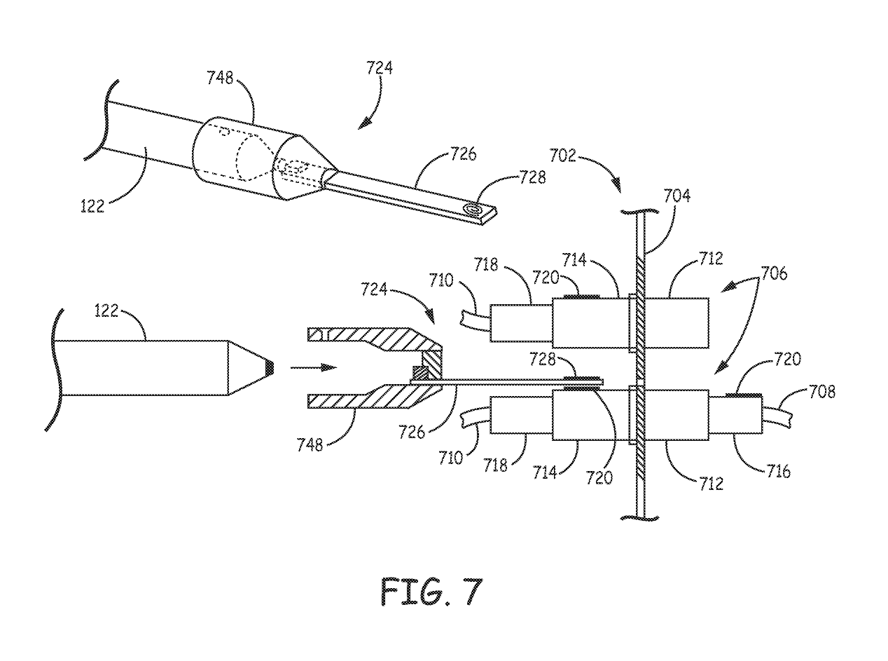

Moreover, although the preceding examples have been described above in connection with using an RFID reader pen and extender to read RFID tags mounted to connectors, it is to be understood that that such an extender can be used to read RFID tags mounted to other items (such an adapter). Also, the extender can be implemented in other ways. One exemplary alternative embodiment is shown in FIG. 7.

In general, the patch panel system 702 and extender 724 shown in FIG. 7 are generally the same as the patch panel system 102 and extender 124 described above in connection with FIGS. 1-6, except as described below. The elements of the exemplary embodiment shown in FIG. 7 that are similar to corresponding elements of the exemplary embodiment shown in FIGS. 1-6 are referenced in FIG. 7 using the same reference numerals used in FIGS. 1-6 but with the leading numeral changed from a “1” to a “7”. Except as described below, the description of the elements set forth above in connection with the exemplary embodiment shown in FIGS. 1-6 applies to the corresponding elements of the exemplary embodiment shown in FIG. 7 but generally will not be repeated in connection with FIG. 7 for the sake of brevity.

In the exemplary embodiment shown in FIG. 7, the extender 724 comprises a nib 726 that is implemented using a printed circuit board (PCB) that is used to implement a circuit of the type described above in connection with FIG. 6 for coupling a tip coil to a pickup coil.

In the exemplary embodiment shown in FIG. 7, the extender 724 includes a pen adapter 748 that is configured to receive the tip of the RFID reader pen 122 when the extender 124 is attached to the body of the RFID reader pen 122 by sliding the pen adapter 748 over the top portion of the RFID reader pen 122. The pen adapter 748 is configured to receive the tip of the RFID reader pin 122 and stop the extender 124 from being slid further down the top portion of the RFID reader pen 122. In the exemplary embodiment shown in FIG. 7, the pen adapter 748 is larger than in the embodiment shown in FIGS. 1-6 and is configured to cover the tip of the pen 122 as well as portion of the shaft of the pen 122. That is, in the exemplary embodiment shown in FIG. 7, the pen adapter 748 is configured to perform both the function of the pen adapter 148 and the collar 127 of the embodiment shown in FIGS. 1-6. The cap 727 can be implemented using clear or translucent plastic so that any LEDs inside the tip of the RFID pen 122 are still visible.

Also, in the exemplary embodiment shown in FIG. 7, the extender 724 and RFID pen 122 are used to read RFID tags 720 that are mounted to the fiber adapters 706 that are inserted into to the patch panel 704 as well as any RFID tags 720 mounted to the connectors 718 or 716.

In the embodiments described above, the RFID reader is implemented using an RFID reader pen; however, as noted above, the RFID reader need not be implemented using an RFID reader pen and can be implemented using other types of RFID readers including, for example, other types of handheld RFID readers.

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

### Example Embodiments

Example 1 includes an apparatus for reading an RFID tag comprising: an RFID reader comprising: an RFID transceiver and a first coil; and an extender configured to attach to the RFID reader, the extender comprising a second coil; wherein the extender is configured to couple the first coil and the second coil to one another when the extender is attached to the RFID reader.

Example 2 includes the apparatus of Example 1, wherein the extender comprises a circuit to couple the first coil and the second coil, wherein the circuit comprises the second coil.

Example 3 includes the apparatus of Example 2, wherein the circuit further comprises a third coil, wherein the extender is configured to position the third coil near the first coil when the extender is attached to the RFID reader so that the first coil and the second coil are coupled to one another via the third coil.

Example 4 includes the apparatus of any of the Examples 2-3, wherein the circuit further comprises a capacitor to tune the circuit to improve the coupling factor between the first coil and the second coil.

Example 5 includes the apparatus of any of the Examples 1-4, wherein the extender is configured to inductively couple the first coil and the second coil to one another when the extender is attached to the RFID reader.

Example 6 includes the apparatus of any of the Examples 1-5, wherein the extender is configured to couple the first coil and the second coil to one another when the extender is attached to the RFID reader in at least one of a wireless manner and a wired manner.

Example 7 includes the apparatus of any of the Examples 1-6, wherein the extender comprises an elongated structure, wherein the second coil is positioned near one end of the elongated structure.

Example 8 includes the apparatus of any of the Examples 1-7, wherein the extender is configured to be removably attached to the RFID reader.

Example 9 includes the apparatus of any of the Examples 1-8, wherein at least one of the first coil and the second coil comprises multiple turns of wire.

Example 10 includes the apparatus of any of the Examples 1-9, wherein at least one of the first coil and the second coil comprises an inductor.

Example 11 includes the apparatus of any of the Examples 1-10, wherein at least one of the first coil and the second coil comprises a low profile printed circuit board (PCB) planar inductor or transformer.

Example 12 includes the apparatus of any of the Examples 1-11, wherein the extender further comprises an adapter configured to receive at least a portion of the RFID reader.

Example 13 includes the apparatus of Example 12, wherein the adapter is formed from a material through which it can be visually determined if a light emitting diode (LED) included in the RFID reader is illuminated or not.

Example 14 includes the apparatus of any of the Examples 1-13, wherein the RFID reader comprises a handheld RFID reader.

Example 15 includes the apparatus of any of the Examples 1-14, wherein the RFID reader comprises RFID reader pen.

Example 16 includes an extender for use with an RFID reader that is configured to read an RFID tag using a first coil included in the RFID reader, the extender comprising: an elongated structure configured to attach to the RFID reader; and a second coil attached to the elongated structure; wherein the extender is configured to couple the first coil and the second coil to one another when the extender is attached to the RFID reader.

Example 17 includes the extender of Example 16, wherein the extender comprises a circuit to couple the first coil and the second coil, wherein the circuit comprises the second coil.

Example 18 includes the extender of Example 17, wherein the circuit further comprises a third coil, wherein the extender is configured to position the third coil near the first coil when the extender is attached to the RFID reader so that the first coil and the second coil are coupled to one another via the third coil.

Example 19 includes the apparatus of any of the Examples 17-18, wherein the circuit further comprises a capacitor to tune the circuit to improve the coupling factor between the first coil and the second coil.

Example 20 includes the apparatus of any of the Examples 16-19, wherein the extender is configured to inductively couple the first coil and the second coil to one another when the extender is attached to the RFID reader.

Example 21 includes the apparatus of any of the Examples 16-20, wherein the extender is configured to couple the first coil and the second coil to one another when the extender is attached to the RFID reader in at least one of a wireless manner and a wired manner.

Example 22 includes the apparatus of any of the Examples 16-21, wherein the elongate structure comprises a nib, wherein the second coil is positioned on the nib near a tip of the nib.

Example 23 includes the apparatus of any of the Examples 16-22, wherein the extender is configured to be removably attached to the RFID reader.

Example 24 includes the apparatus of any of the Examples 16-23, wherein at least one of the first coil and the second coil comprises multiple turns of wire.

Example 25 includes the apparatus of any of the Examples 16-24, wherein at least one of the first coil and the second coil comprises an inductor.

Example 26 includes the apparatus of any of the Examples 16-25, wherein at least one of the first coil and the second coil comprises a low profile printed circuit board (PCB) planar inductor or transformer.

Example 27 includes the apparatus of any of the Examples 16-26, wherein the extender further comprises an adapter configured to receive at least a portion of the RFID reader.

Example 28 includes the apparatus of Example 27, wherein the adapter is formed from a material through which it can be visually determined if a light emitting diode (LED) included in the RFID reader is illuminated or not.

Example 29 includes the apparatus of any of the Examples 16-28, wherein the RFID reader comprises a handheld RFID reader.

Example 30 includes the apparatus of any of the Examples 16-29, wherein the RFID reader comprises a RFID reader pen.

What is claimed:

1. An apparatus for reading an RFID tag comprising:
an RFID reader comprising: an RFID transceiver and a first coil; and
an extender configured to attach to the RFID reader, the extender comprising a second coil;
wherein the extender is configured to couple the first coil and the second coil to one another when the extender is attached to the RFID reader.

2. The apparatus of claim 1, wherein the extender comprises a circuit to couple the first coil and the second coil, wherein the circuit comprises the second coil.

3. The apparatus of claim 2, wherein the circuit further comprises a third coil, wherein the extender is configured to position the third coil near the first coil when the extender is attached to the RFID reader so that the first coil and the second coil are coupled to one another via the third coil.

4. The apparatus of claim 2, wherein the circuit further comprises a capacitor to tune the circuit to improve the coupling factor between the first coil and the second coil.

5. The apparatus of claim 1, wherein the extender is configured to inductively couple the first coil and the second coil to one another when the extender is attached to the RFID reader.

6. The apparatus of claim 1, wherein the extender is configured to couple the first coil and the second coil to one another when the extender is attached to the RFID reader in at least one of a wireless manner and a wired manner.

7. The apparatus of claim 1, wherein the extender comprises an elongated structure, wherein the second coil is positioned near one end of the elongated structure.

8. The apparatus of claim 1, wherein the extender is configured to be removably attached to the RFID reader.

9. The apparatus of claim 1, wherein at least one of the first coil and the second coil comprises multiple turns of wire.

10. The apparatus of claim 1, wherein at least one of the first coil and the second coil comprises an inductor.

11. The apparatus of claim 1, wherein at least one of the first coil and the second coil comprises a low profile printed circuit board (PCB) planar inductor or transformer.

12. The apparatus of claim 1, wherein the extender further comprises an adapter configured to receive at least a portion of the RFID reader.

13. The apparatus of claim 12, wherein the adapter is formed from a material through which it can be visually determined if a light emitting diode (LED) included in the RFID reader is illuminated or not.

14. The apparatus of claim 1, wherein the RFID reader comprises a handheld RFID reader.

15. The apparatus of claim 1, wherein the RFID reader comprises RFID reader pen.

16. An extender for use with an RFID reader that is configured to read an RFID tag using a first coil included in the RFID reader, the extender comprising:
an elongated structure configured to attach to the RFID reader; and
a second coil attached to the elongated structure;
wherein the extender is configured to couple the first coil and the second coil to one another when the extender is attached to the RFID reader.

17. The extender of claim 16, wherein the extender comprises a circuit to couple the first coil and the second coil, wherein the circuit comprises the second coil.

18. The extender of claim 17, wherein the circuit further comprises a third coil, wherein the extender is configured to position the third coil near the first coil when the extender is attached to the RFID reader so that the first coil and the second coil are coupled to one another via the third coil.

19. The extender of claim 17, wherein the circuit further comprises a capacitor to tune the circuit to improve the coupling factor between the first coil and the second coil.

20. The extender of claim 16, wherein the extender is configured to inductively couple the first coil and the second coil to one another when the extender is attached to the RFID reader.

21. The extender of claim 16, wherein the extender is configured to couple the first coil and the second coil to one another when the extender is attached to the RFID reader in at least one of a wireless manner and a wired manner.

22. The extender of claim 16, wherein the elongated structure comprises a nib, wherein the second coil is positioned on the nib near a tip of the nib.

23. The extender of claim 16, wherein the extender is configured to be removably attached to the RFID reader.

24. The extender of claim 16, wherein at least one of the first coil and the second coil comprises multiple turns of wire.

25. The extender of claim 16, wherein at least one of the first coil and the second coil comprises an inductor.

26. The extender of claim 16, wherein at least one of the first coil and the second coil comprises a low profile printed circuit board (PCB) planar inductor or transformer.

27. The extender of claim 16, wherein the extender further comprises an adapter configured to receive at least a portion of the RFID reader.

28. The extender of claim 27, wherein the adapter is formed from a material through which it can be visually determined if a light emitting diode (LED) included in the RFID reader is illuminated or not.

29. The extender of claim 16, wherein the RFID reader comprises a handheld RFID reader.

30. The extender of claim 16, wherein the RFID reader comprises a RFID reader pen.
